(19) United States
(12) Patent Application Publication
(10) Pub. No.: US 2010/0178901 A1
(43) Pub. Date: Jul. 15, 2010

(54) METHOD AND ARRANGEMENT IN A COMMUNICATION DEVICE FOR REGISTERING AN ALARM TIME

(75) Inventor: Dan GAVIE, Malmo (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/354,402

(22) Filed: Jan. 15, 2009

(51) Int. Cl. H04W 4/00; H04B 7/00

(52) U.S. Cl. 455/414.2; 455/41.2

(57) ABSTRACT

A method and an arrangement in a communication device for registering a first point in time for triggering of an alarm are provided. The communication device may support a short range radio access technology. The communication device may effect payment of a product and/or a service by communicating with the radio base station. The communication device may receive, from the radio base station, information regarding a second point in time, associated with the product and/or service. The communication device may register the first point in time for triggering of the alarm in the communication device. The first point in time may be based on the second point in time indicated by the received information. When the first point in time is reached, the communication device may indicate that the alarm has been triggered.

### TECHNICAL FIELD

The present invention generally relates to a method and an arrangement in a communication device and, more particularly, to registering an alarm time in response to reception of receipt for payment of a product or service paid for by means of the communication device.

### BACKGROUND

Currently, interest in short range radio access technologies is increasing. It is suggested that short range radio access technologies will, in a near future, be incorporated in to a plurality of different types of user devices, such as mobile terminals, personal digital assistants (PDAs), mp3-players, digital cameras, and even light-weight portable computers (e.g., laptops, notebooks, etc.). Such devices may, as consequence of the incorporation of the short range radio access technology, be used for performing payments of every-day products or services, such as mass transit tickets, cinema tickets, tickets for rental of DVD movies, etc., particularly unattended transactions, such as highway tolls, parking fees, etc. These types of payments are often referred to as mobile payments and may take place in any number of public places, such as a parking facility, a shop, a bus stop and the like.

In particular, short range radio access technology, for example, near field communication (NFC), may be incorporated into a mobile terminal, which thus may be used for remitting mobile payments, particularly NFC payments, for instance.

### SUMMARY

Consider the following scenario. A user purchases a service or product which has a certain expiration date and time. This may be the case when a user prepays, for example, a parking fee or a DVD movie rental. An issue arises when the driver's car remains in the parking space/facility beyond the allotted time or the consumer returns the DVD movie past the appointed time. This may, in some cases, result in additional costs to the driver/consumer, in the form extended fees, late fees or the like.

According to an aspect of the invention, a method, in a communication device, for registering a first point in time for triggering of an alarm may be provided. The communication device may support a short range radio access technology. A short range radio access technology-enabled communication system may include the communication device and a radio base station. The communication device may effectuate a payment for a product or service by communicating with the radio base station using the short range radio access technology. The communication device may receive information about a second point in time, associated with the product or service paid for by the effectuated payment, from the radio base station. The communication device may register the first point in time for triggering of the alarm in the communication device. The first point in time may be based on the second point in time indicated by the received information. When the first point in time is reached, the communication device may indicate that the alarm has been triggered.

In some embodiments of the method in the communication device, the first point in time may be set at or before the second point in time.

In some embodiments of the method in the communication device, the method may further include a step of setting the first point in time based on input from a user.

In some embodiments of the method in the communication device, the communication device may be a mobile terminal, a cellular phone, a personal digital assistant (PDA) or the like.

In some embodiments of the method in the communication device, the method may further include a step of receiving a receipt, wherein the receipt may be a receipt for a parking ticket or the like, wherein the second point in time indicates time of expiry of the parking ticket. At or after the expiration time of the parking ticket, it is no longer possible to validly park at the parking space.

In some embodiments of the method in the communication device, the short range radio access technology may include near field communication (NFC), Bluetooth®, or RFID.

According to another aspect of the invention, an arrangement, in a communication device, for registering a first point in time for triggering of an alarm may be provided. The communication device may be configured to support a short range radio access technology. A short range radio access technology-enabled communication system may be configured to include the communication device and a radio base station. The arrangement may include a processing unit configured to effectuate a payment for a product or service by communicating with the radio base station while using the short range radio access technology, and a receiving unit configured to receive information about a second point in time, associated with the product or service paid for by the effectuated payment, from the radio base station. Moreover, the processing unit may further be configured to register the first point in time for triggering of the alarm in the communication device, the first point in time being based on the second point in time indicated by the received information, and to indicate that the alarm has been triggered when the first point in time is reached.

In some embodiments of the arrangement in the communication device, the first point in time may be set at or before the second point in time.

In some embodiments of the arrangement in the communication device, the processing unit may further be configured to set the first point in time based on input from a user.

In some embodiments of the arrangement in the communication device, the processing unit may further be configured to set the first point in time based on input from a user.

In some embodiments of the arrangement in the communication device, the communication device may be a mobile terminal, a cell phone, a PDA, or the like.

In some embodiments of the arrangement in the communication device, the receiving unit may further be configured to receive a receipt, wherein the receipt may be a receipt for a parking ticket or the like, wherein the second point in time indicates time of expiry of the parking ticket. At or after the expiration of the parking ticket, it is no longer possible to validly park at the parking space.

In some embodiments of the arrangement in the communication device, the short range radio access technology may include NFC, Bluetooth®, or RFID.

Because the first point in time for triggering of the alarm may be based on the second point in time received in conjunction with the payment of a product or service, the alarm may be set such as to remind a user about a time relevant for the purchased product or service. In this manner, the present solution may provide a means for facilitating everyday life of a user of the communication device, being equipped with a short range radio access technology. Typically, the short range radio access technology may be used for effectuating a payment for a product or service, such as a parking ticket, a bus ticket, or the rental of a movie.

Further features of, and advantages with, the present invention will become apparent when studying the appended claims and the following description. Those skilled in the art realize that different features of the present invention may be combined to create embodiments other than those described in the following, without departing from the scope of the present invention, as defined by the appended claims.

### BRIEF DESCRIPTION OF THE DRAWINGS

The various aspects of the invention, including its particular features and advantages, will be readily understood from the following detailed description and the accompanying drawings, in which:

FIG. 1 shows a schematic overview of a short range radio communication system, in which the present solution may be implemented;

FIG. 2 shows a schematic, combined signalling and flow chart of an embodiment of a method performed in the short range radio communication system according to FIG. 1;

FIG. 3 shows a schematic flow chart of an embodiment of the method in the communication device; and

FIG. 4 shows a schematic block diagram of an embodiment of the arrangement in the communication device.

### DETAILED DESCRIPTION

Throughout the following description similar reference numerals may be used to denote similar elements, parts, items or features, when applicable.

It is to be understood that the expression “communication device” includes, but is not limited to, a mobile terminal, a mobile phone, a personal digital assistant (PDA), a cellular phone, or other device.

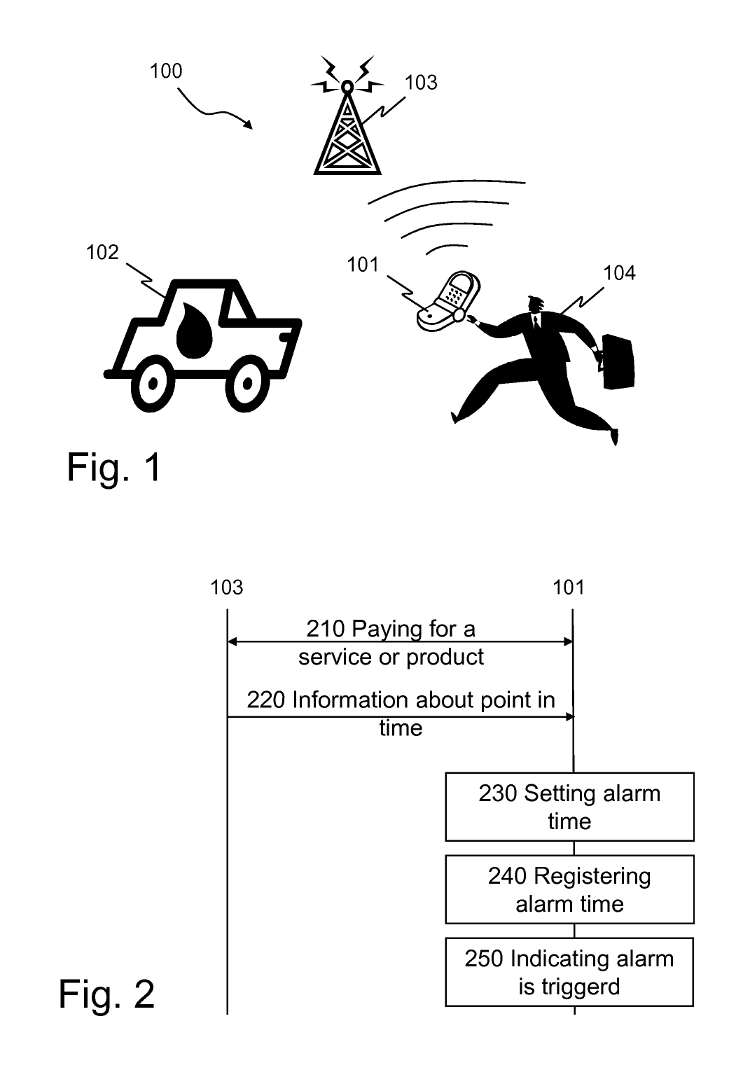

FIG. 1 shows an exemplifying short range radio access technology-enabled communication system 100, in which the present solution may be implemented. FIG. 1 depicts a communication device 101, a vehicle 102, such as a car, an NFC base station 103, and/or a user 104. Short range radio access technology-enabled communication system 100 may include communication device (or mobile terminal) 101 and NFC base station 103. Communication device 101 may be an NFC-enabled communication device.

FIG. 2 depicts a combined signalling and flow chart of an embodiment of a method in short range radio access technology enabled communication system 100. When performing a method according to the present invention, the following steps may be performed.

In step 210, user 104 may enter a parking facility, e.g., a garage or open lot, and pay the ticket by using (NFC-enable) communication device 101. In steps 220, 230, 240, when paying for the ticket, an alarm may be automatically set. Because the NFC application can detect the amount of time that the parking ticket is valid, user 104 need not keep track of the time for expiration of the purchased parking time. In other words, communication device 101 may be configured based on the various parameters related to the context of the payment, for example, in this case, an alarm may be set in communication device 101. It may preferred to apply embodiments of the present invention for payment of relatively small amounts, such the amounts of parking tickets, bus tickets, DVD rental costs, and the like.

In a step 250, when, for example, two hours have elapsed, communication device 101 may detects that only 10 minutes remain before the parking ticket expires. Consequently, the alarm may activate and indicate to user 104 that only 10 minutes remain before the parking ticket expires and, hence, the car may no longer validly remain parked without incurring additional charges. In this manner, the experience for user 104 when paying for parking by means of an NFC application implemented in communication device 101 may be improved.

In some embodiments, other information may be transferred to communication device 101 during the purchasing transaction. In the parking scenario, for example, information regarding the location of the parking facility, such as garage number, floor number, entrance, lot number, assigned space, etc., may be received by communication device 101, in which case, user 104 may consult communication device 101 for such information, should, for example, the actual ticket itself be lost.

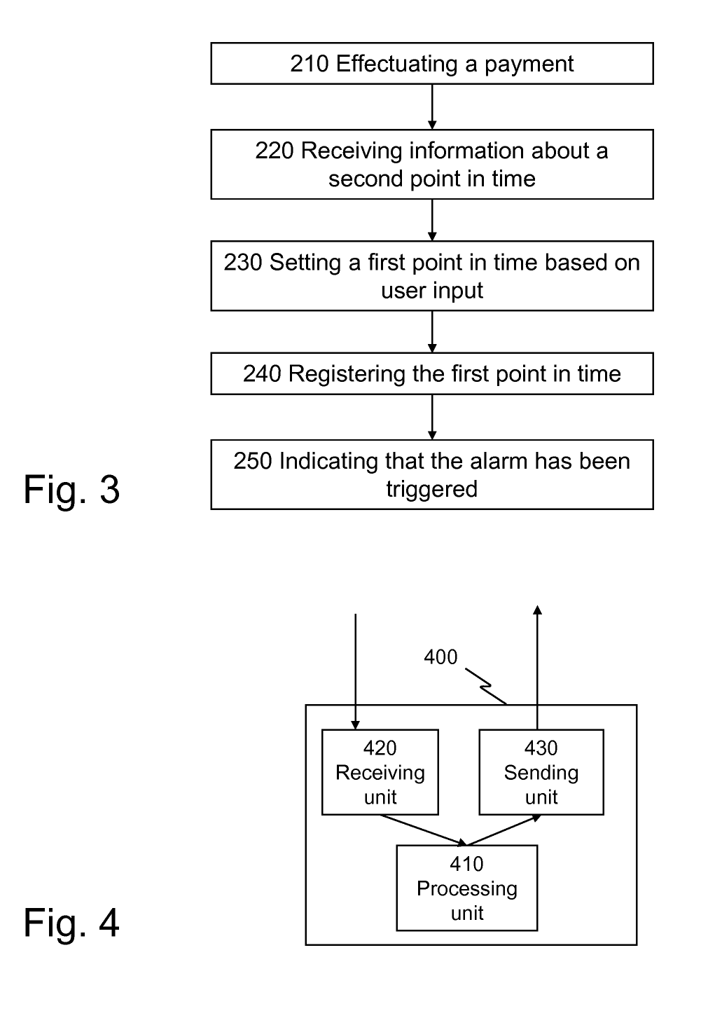

FIG. 3 illustrates the steps of an embodiment of a method, performed in communication device 101, for registering a first point in time for triggering of an alarm. The first point in time may be registered in response to reception of information about a second point in time. The second point in time may be associated with a product and/or service paid for using means of communication device 101. Communication device 101 may be configured to support a short range radio access technology. A short range radio access technology-enabled communication system 100 may include communication device 101 and radio base station 103.

In step 210, communication device 101 may effectuate (remit) a payment for a product and/or a service, such as a parking ticket, by communicating with radio base station 103 using the short range radio access technology. The parking ticket may correspond to a particular space, i.e., be valid for a certain designated parking spot.

In step 220, communication device 101 may receive information about a second point in time, associated with the product and/or service associated with the effectuated payment, from radio base station 103, such as an NFC base station. The second point in time may indicate a time of expiry, for example, for the parking ticket. In step 230, communication device 101 may set the first point in time based on input from user 104. In other words, user 104 may select an adjustable period that is in advance of the actual expiration time. For example, some users may be opt to be alerted 10 minutes before the expiration time, whereas in some circumstances, it may be desirable to be reminded 1 hour before the expiration time. This step may, in some embodiments, be replaced by a predetermined period of time, indicating how much in advance the alarm should be triggered. Any number of incremental predetermined times may be provided for selection, for example, from a menu.

In step 240, communication device 101 may register and/or set the first point in time for triggering of the alarm in communication device 101. The first point in time may be based on the second point in time indicated by the received information. For example, communication device 101 may set an alarm at the expiration time of the parking ticket decremented by an optional period specified by the user when the previously-described step has been performed. The optional period may be selected.

In step 250, when the first point in time is reached, communication device 101 may generate an indication that the alarm has been triggered, optionally by visual, tactual and/or sounding means or a combination thereof. Moreover, communication device 101 may, optionally, instruct the alarm functionality of communication device 101 to indicate that the alarm has been triggered.

In some embodiments of the method in communication device 101, the first point in time is set at or before the second point in time.

In some embodiments of the method in communication device 101, communication device 101 may include a mobile terminal, a cell phone, a PDA, or the like.

In some embodiments of the method implemented via communication device 101, the method may further include a step of receiving a receipt, wherein the receipt is a receipt for a parking ticket or the like, wherein the second point in time indicates time of expiry of the parking ticket. At and/or after the expiration time of the parking ticket, it is no longer possible to validly park at the parking spot.

In some embodiments of the method implemented in communication device 101, the short range radio access technology may include NFC, Bluetooth®, and/or RFID.

With reference to FIG. 4, there is shown a schematic functional block diagram of an embodiment of an arrangement 400 in communication device 101 for registering a first point in time for triggering of an alarm. Communication device 101 may be configured to support a short range radio access technology. Short range radio access technology-enabled communication system 100 may include communication device 101 and radio base station 103. Arrangement 400 may include a processing unit 410 that may be configured to effectuate a payment for a product and/or service by communicating with radio base station 103 via short range radio communication, and a receiving unit 420 may be configured to receive information about a second point in time, associated with the product and/or service paid for by the effectuated payment, from radio base station 103. Processing unit 410 may further be configured to register the first point in time for triggering of the alarm in communication device 101, the first point in time being based on the second point in time indicated by the received information. Processing unit 410 may further be configured to indicate that the alarm has been triggered when the first point in time is reached. Arrangement 400 may include a sending unit 430.

In some embodiments of arrangement 400 in communication device 101, the first point in time may be set at or before the second point in time.

In some embodiments of arrangement 400 in communication device 101, processing unit 410 may be further configured to set the first point in time based on input from a user.

In some embodiments of arrangement 400 in communication device 101, communication device 101 may include a mobile terminal, a cell phone, a PDA, or the like.

In some embodiments of arrangement 400 in communication device 101, receiving unit 420 may further be configured to receive a receipt, wherein the receipt is a receipt for a parking ticket or the like, wherein the second point in time indicates time of expiry of the parking ticket. At and/or after the expiration time of the parking ticket, it is no longer possible to validly park at the parking spot. In some embodiments, the receipt in communication device 101 may be used as proof of purchase in lieu of the actual ticket itself, for example, when the ticket is lost. Communication device may be configured to display or otherwise render the receipt (e.g., print out), and/or communicate the contents of the receipt electronically, using, for example, short range radio communication to communicate via radio base station 103.

In some embodiments of arrangement 400 in communication device 101, the short range radio access technology may include NFC, Bluetooth®, and/or RFID.

In a further exemplifying scenario, in which embodiments of the present invention may be implemented, it is contemplated that an alarm may be set to remind a movie theater-goer about the starting time of a movie as described by the steps below. At the movie theater, an NFC base station may be located, by which visitors to the movie patrons may purchase tickets with their NFC-enabled mobile phones or the like, for example, unassisted by a theatre attendant.

In a first step, the movie-goer may select, from a movie list (e.g., titles, respective start times, respective run times, content ratings, prices, corresponding awards, etc.) displayed via a display of the mobile phone, a movie for admittance. In a next step, the patron purchases the corresponding movie ticket(s) by means of the NFC-enabled mobile phone via communications with the NFC base station. Responsive to the remittance of the payment, the mobile phone may receive a receipt from the NFC base station. Information of the receipt may include, for example, the seating (i.e., admittance) time and/or starting time of the movie. Other information may include seating information, such as an assigned seat number, which may be presented to the user, for example, when the actual tickets are lost. In a following step, the mobile phone may set an alarm based on the received seating time and/or the starting time.

Now, the movie patron may spend time before the start of the movie unencumbered with repeatedly checking the time and relating the current time to that of the start of the movie to the recollection of the movie patron. Because the mobile phone will remind about the starting time of the movie, the movie patron does not have to worry about missing the start of the movie.

At a given time, the following step is performed in the mobile phone. The mobile phone triggers the alarm set in order to alert the mobile phone user about the starting time of the movie. The time of reminding may be selectable by the user or may be predetermined. For some cases, it may be preferred to set the time of the reminder only a few minutes before the starting time of the movie, while for some other cases it may be suitable to set the time of the reminder several hours before the starting time of the movie.

In yet another exemplifying scenario, to which embodiments of the present invention may be implemented, it is contemplated that an alarm may be set to remind a person, renting some item, such as a DVD movie, a bicycle, ski equipment, a watercraft, a car, or the like, about an expiration time (e.g., time of return) of a rental period. The case when a DVD movie is rented is described in more detail below.

In the shop, kiosk, etc., where DVD movies may be rented, a Bluetooth® base station may be located and configured to function as a payment means for the DVD movies. A user, wishing to rent a DVD movie, may have a Bluetooth®-enabled mobile phone or the like.

In a first step, the user may select a movie to rent. Next, the user may use a Bluetooth®-enabled mobile phone to pay for a rental period of the movie while communicating with a Bluetooth®-base station. In a further step, responsive to the payment, the mobile phone may receive a point in time indicating the expiration of the rental period. Thereafter, the mobile phone may set an alarm time based on the point in time indicating the expiration of the rental period. The user may now be untroubled about when the rental period expires, go home, and enjoy the movie without needlessly worrying about late fees.

In another step, when the alarm time is reached, the mobile phone may generate an alert to the user about the expiration of the rental period and render an alarm. As described above, it may be preferred to set the time of triggering the alarm for presentation some time period in advance of the expiration of the rental period.

In still further exemplifying scenarios, to which embodiments of the present solution may be applied, it is contemplated that an alarm may be set to remind a traveller about the departure time of a bus, a train, an airplane, or the like. Similar steps and functions as described above will be applied as understood by the person skilled in the art.

Even though the invention has been described with reference to specific exemplifying embodiments thereof, many different alterations, modifications and the like will become apparent for those skilled in the art. The described embodiments are therefore not intended to limit the scope of the invention, which is defined by the appended claims.

What is claimed is:

1. In a communication device, a method for registering a first point in time for triggering of an alarm, where the communication device supports a short range radio access technology, where a short range radio access technology-enabled communication system includes the communication device and a radio base station, the method comprising:
effectuating a payment for at least one of a product or a service via communication with the radio base station via the short range radio access technology;
receiving, from the radio base station, information about a second point in time, associated with the at least one of the product or service;
registering the first point in time for triggering the alarm in the communication device, the first point in time being based on the second point in time indicated by the received information; and
when the first point in time is reached, indicating that the alarm has been triggered.

2. The method of claim 1, where the first point in time is set at no later than the second point in time.

3. The method of claim 1, further comprising:
setting the first point in time based on input from a user.

4. The method claim 1, where the communication device is a mobile terminal, a cellular phone, or a personal digital assistant.

5. The method of claim 1, further comprising:
receiving a receipt, where the receipt comprises a parking ticket, and the second point in time indicates time of expiry of the parking ticket.

6. The method of claim 1, where the short range radio access technology comprises near field communication, Bluetooth®, or radio frequency identification.

7. An arrangement in a communication device for registering a first point in time for triggering of an alarm, where the communication device supports a short range radio access technology, where a short range radio access technology-enabled communication system comprises the communication device and a radio base station, the arrangement comprising:
a processing unit to remit a payment for at least one of a product or a service by communicating with the radio base station using the short range radio access technology; and
a receiving unit to receive information, from the radio base station, indicating a second point in time, associated with the at least one of the product or service corresponding to the payment, where the processing unit is further to register the first point in time for triggering the alarm in the communication device, the first point in time being based on the second point in time indicated by the received information, and the processing unit is further to indicate that the alarm has been triggered when the first point in time is reached.
